(19) United States
(12) Patent Application Publication
(10) Pub. No.: US 2024/0389178 A1
(43) Pub. Date: Nov. 21, 2024

(54) MULTIPLE ACCESS PROTOCOL DATA UNIT SESSION ESTABLISHMENT WITH A SINGLE SUBSCRIPTION

(71) Applicant: QUALCOMM Incorporated, San Diego, CA (US)

(72) Inventors: Waqar ZIA, Munich (DE); Dario Serafino TONESI, San Diego, CA (US); Amer CATOVIC, San Diego, CA (US); Lenaig Genevieve CHAPONNIERE, La Jolla, CA (US); Sebastian SPEICHER, Wallisellen (CH); Stefano FACCIN, San Ysidro, CA (US); Haris ZISIMOPOULOS, London (GB); Ajith Tom PAYYAPPILLY, San Diego, CA (US)

(21) Appl. No.: 18/690,663

(22) PCT Filed: Sep. 23, 2022
(86) PCT No.: PCT/US2022/076971

§ 371 Date: Mar. 8, 2024

(30) Foreign Application Priority Data
Nov. 1, 2021 (GR) 20210100759

(51) Int. Cl. H04W 76/15; H04W 40/02; H04W 48/18

(52) U.S. Cl. CPC H04W 76/15; H04W 40/026; H04W 48/18

(57) ABSTRACT

Certain aspects of the present disclosure provide techniques for establishing a dual third generation partnership project (3 GPP) access protocol data unit (PDU) session. An example method performed by a user equipment includes selecting a first access link for a protocol data unit (PDU) session, selecting a second access link based on the first access link, and establishing the PDU session based on the selected first access link and the second access link.

### CROSS-REFERENCE TO RELATED APPLICATIONS

This application claims benefit of and priority to Greece Application No. 20210100759, filed Nov. 1, 2021, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications, and more particularly, to techniques for establishing a multiple access (MA) protocol data unit (PDU) session using a single subscription.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method may include selecting a first access link for a protocol data unit (PDU) session, selecting a second access link based on the first access link, and establishing the PDU session based on the selected first access link and the second access link.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a wireless communication network that supports multi-access Protocol Data Unit (MA PDU) session establishment.

FIG. 6 illustrates an example wireless communication network architecture for facilitating dual 3GPP access for a MA PDU session in different public land mobile networks (PLMNs).

FIG. 7 illustrates establishing a dual 3GPP access for a MA PDU session via different radio access technologies (RATs) in a PLMN.

FIG. 8 illustrates an example call flow diagram illustrating operations for establishing a dual 3GPP access PDU session with ATSSS functionality.

FIG. 9A illustrates an example steering of roaming (SoR) command.

FIG. 9B illustrates an example header of the SoR command.

FIG. 10 illustrates an example acknowledgement message for acknowledging receipt of the SoR command.

FIG. 11 depicts a method for wireless communications.

FIG. 12 depicts aspects of an example communications device.

### DETAILED DESCRIPTION

Aspects of the present disclosure provide apparatuses, methods, processing systems and computer-readable mediums for a single subscription UE establishing a MA PDU session with two 3^{rd} Generation Partnership Project (3GPP)-based access links. Simultaneously using two 3GPP access links from different public land mobile networks (PLMNs) combined with a single set of user equipment (UE) credentials may boost capacity, increase service coverage, and improve resource sharing between PLMNs and/or radio access technologies (RATs). Advantageously, a UE may realize these benefits without inputting access credentials. In accordance with aspects of the present disclosure, a single subscription UE selects a secondary access link based, at least in part, on an established primary access link of the PDU session. This allows the UE to select a PLMN/RAT suitable for access traffic steering, switching and splitting (ATSSS) with the established link, instead of the highest ranked PLMN/RAT in a priority list.

### Introduction to Wireless Communication Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

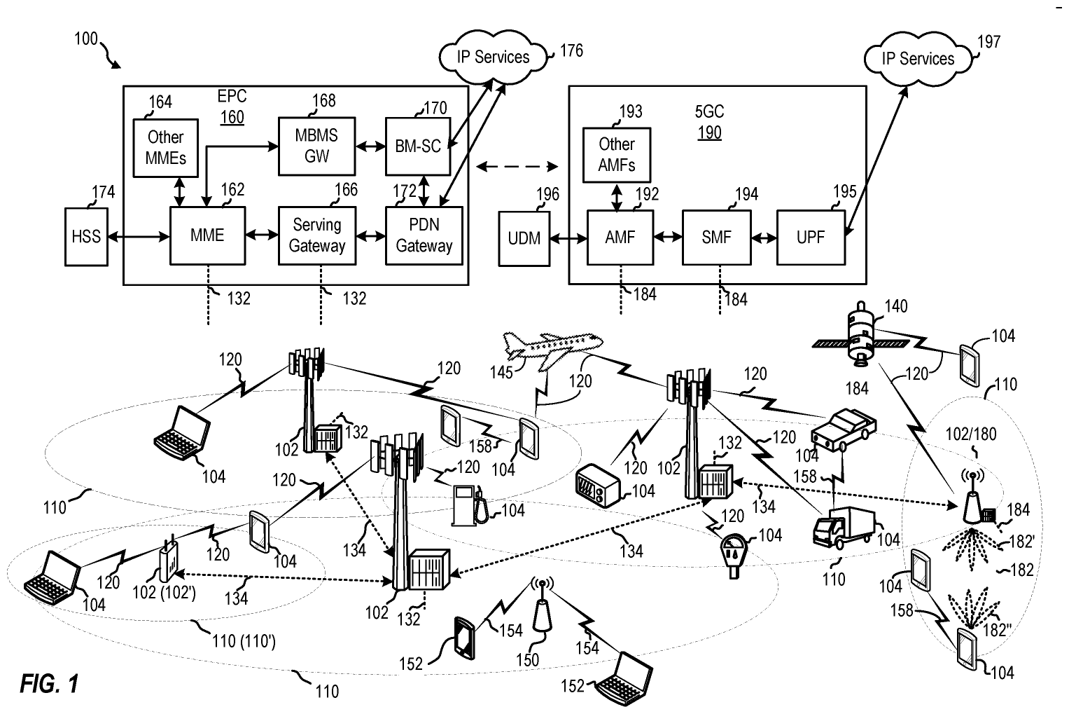

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

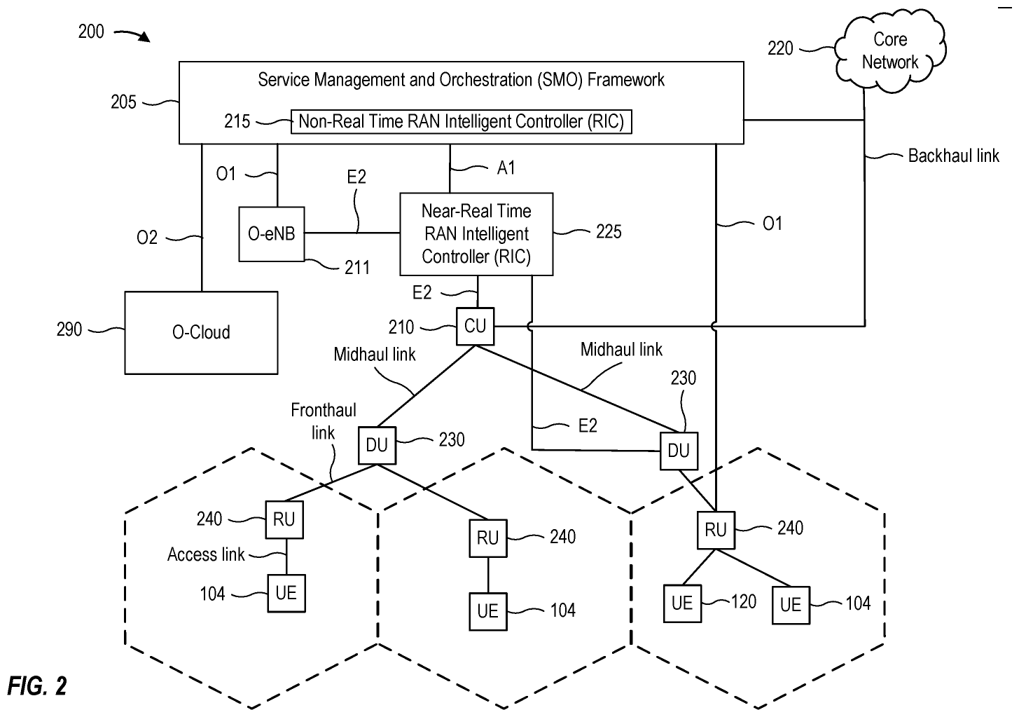

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5GNR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

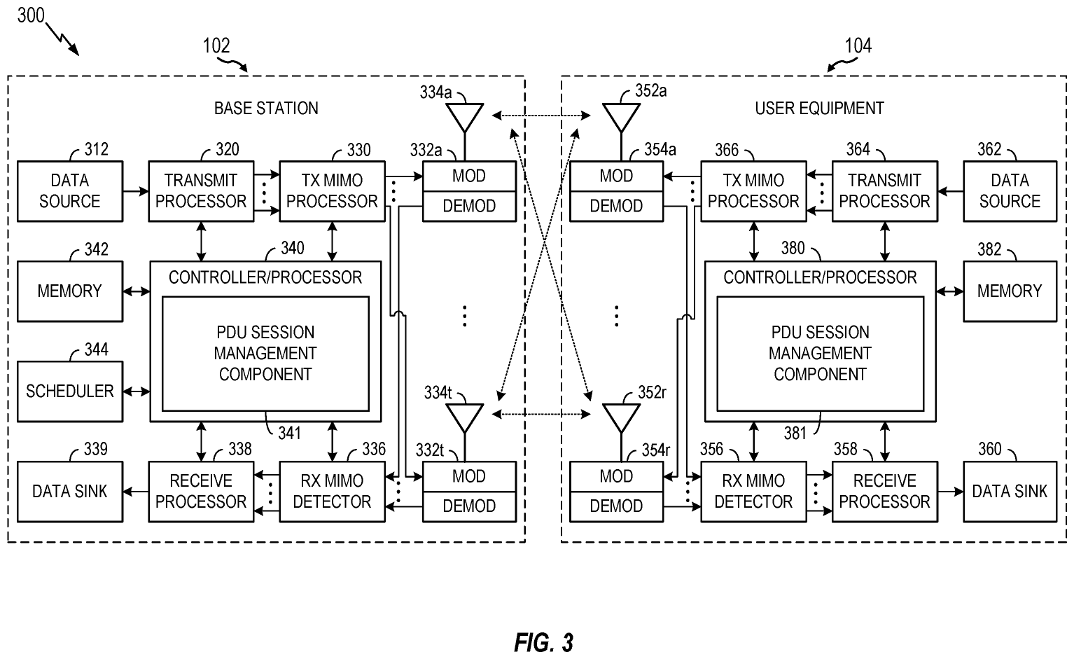

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

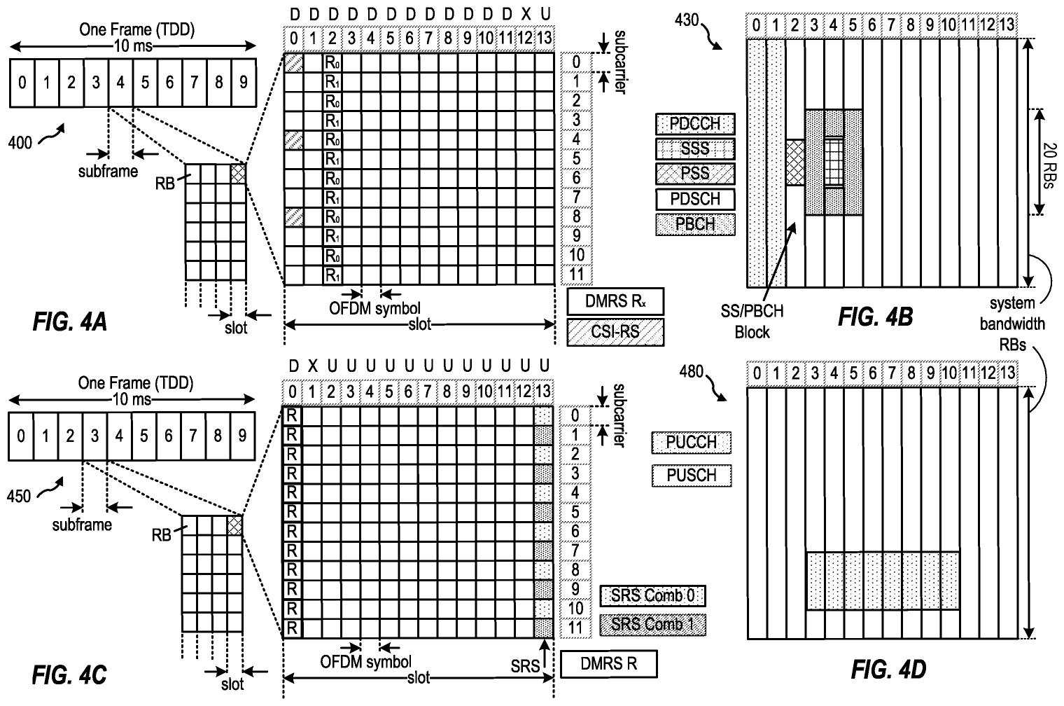

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5GN NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (p) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2p slots/subframe. The subcarrier spacing and symbol length/duration are a function of the numerology. The subcarrier spacing may be equal to 2×15 kHz, where is the numerology 0 to 5. As such, the numerology p=0 has a subcarrier spacing of 15 kHz and the numerology p=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology p=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Access Traffic Steering Switching and Splitting Functionality

In some cases, wireless communication networks, such as wireless communication network 100, may support multi-access protocol data unit (MA PDU) session establishment in which a PDU session may be associated with at least two different access links, such as two or more 3GPP-based access links or a 3GPP-based access link and a non-3GPP-based access link.

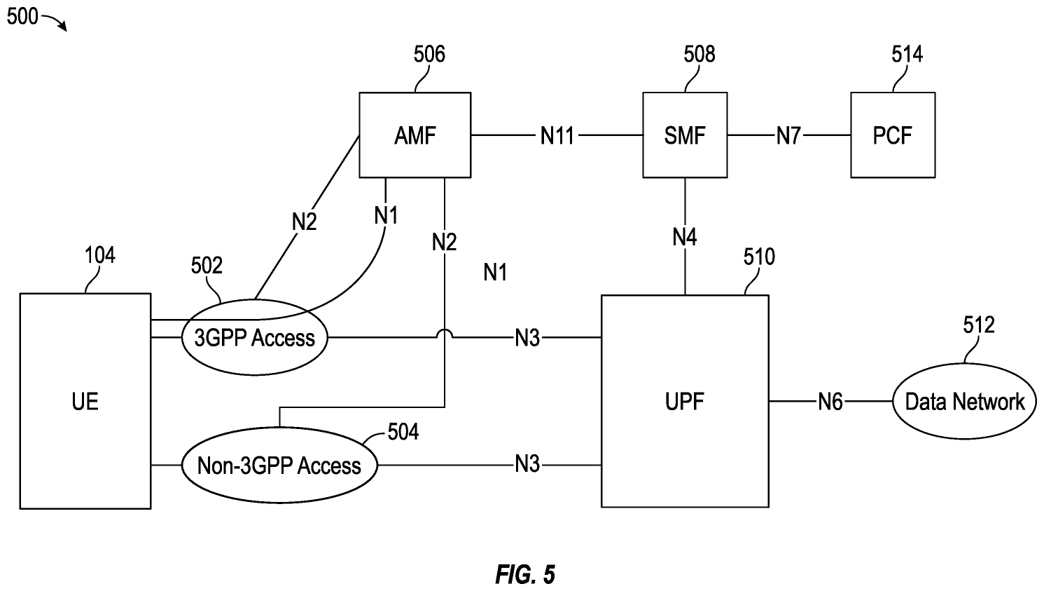

FIG. 5 illustrates a wireless communication network 500 that supports MA PDU session establishment. As shown, the wireless communication network 500 includes the UE 104, a 3GPP radio access network (RAN) 502, a non-3GPP access network (AN) 504, an Access and Mobility Management Function (AMF) 506, a Session Management Function (SMF) 508, a User Plane Function (UPF) 510, a 5G core (5GC) or Evolved Packet core (EPC) data network 512, and a policy control function (PCF) 514. In some cases, the AMF 506 may be an example of the AMF 192 illustrated in FIG. 1, the SMF 508 may be an example of the SMF 194 illustrated in FIG. 1, and the UPF 510 may be an example of the UPF 195, 192 illustrated in FIG. 1.

The AMF 506 may communicate with a base station, the SMF 508, and the UPF 510 for access and mobility management of wireless access devices, such as the UE 104, in wireless communication network 500. The SMF 508 may be responsible for interacting with a decoupled data plane, creating, updating and removing PDU sessions and managing session context with the UPF 510. In some cases, the wireless communication network 500 may also include an N3 interworking function (N3IWF), which interfaces to 5G core network control plane functions and is responsible for routing messages outside 5G RAN.

In an Access Stratum (AS) layer, a RAN (e.g., 3GPP RAN 502 and/or a non-3GPP AN 504) provides radio access for UE 104 via a radio access technology (RAT). In a Non-Access Stratum (NAS) layer, the AMF 506 and the SMF 508 communicate with the RAN and a core network (e.g., 5GC or EPC) for access and mobility management and PDU session management of wireless access devices in the wireless communication network 500. 3GPP RAN 502 may include base stations (gNBs or eNBs, such as the BS 102) providing radio access for UE 104 via various 3GPP RATs including 5G, 4G, and 3G/2G. Non-3GPP AN 504 may include access points (APs) providing radio access for UE 104 via a non-3GPP RAT, such as 802.11-based wireless technology (e.g., Wi-Fi). UE 104 can obtain access to data network 512 through 3GPP RAN 502, AMF 506, SMF 508, and UPF 510. UE 105 can also obtain access to data network 512 through non-3GPP AN 504, the N3IWF, AMF 506, SMF 508, and UPF 510.

5G networks are packet-switched (PS) Internet Protocol (IP) networks, delivering all data traffic in IP packets and providing users with always-on IP connectivity. When a UE, such as the UE 104, joins an evolved packet system (EPS) network (e.g., 5G, 4G, etc.), a Packet Data Network (PDN) address may be assigned to the UE for connection to the PDN. In 4G, EPS has defined a Default EPS Bearer to provide the always-on IP connectivity. In 5G, a PDU session establishment procedure is parallels a PDN connection procedure in 4G. A PDU session defines the association between the UE 104 and the data network 512 that provides a PDU connectivity service. Each PDU session is identified by a PDU session ID, and may include multiple QoS flows and QoS rules.

Each PDU session can be established over the 3GPP RAN 502 or over a non-3GPP AN 504 for radio access. 5G session management (SGSM) for PDU sessions over both 3GPP access and non-3GPP access may be managed by AMF 506 and SMF 508 via NAS signaling. Network operators are seeking ways to balance data traffic between 3GPP access and non-3GPP access in a way that is transparent to users and reduces mobile network congestion. In 5G, certain UEs may be simultaneously connected to both 3GPP access and non-3GPP access, allowing 5G networks to take advantage of these multiple accesses to improves the user experience and optimize traffic distribution across various accesses.

As such, MA PDU sessions have been introduced in 5G. A MA PDU session uses one 3GPP access network or one non-3GPP access network at a time, or simultaneously uses one 3GPP access network and one non-3GPP access network. In some cases, the UE 104 and the wireless communication network 500 can support Access Traffic Steering Switching and Splitting (ATSSS) functionalities to distribute traffic over a first access link to the 3GPP RAN 502 and a second access link to the non-3GPP AN 504 for an established MA PDU session.

For example, after establishment of an MA PDU session, and when there are user-plane resources on both the 3GPP RAN 502 and the non-3GPP AN 504, the UE 104 may apply a network-provided policy (e.g., ATSSS rules) and considers local conditions (e.g., network interface availability, signal loss conditions, etc.) for deciding how to distribute uplink traffic across the first access link to the 3GPP RAN 502 and the second access link to the non-3GPP AN 504. Similarly, the UPF 510, which may anchor the MA PDU session, applies network-provided policy (e.g., N4 rules) and feedback information received from the UE 104 via a user-plane (such as access network unavailability or availability) for deciding how to distribute the downlink traffic across the 3GPP RAN 502 and the non-3GPP AN 504. When there are user-plane resources on only one access network (e.g., either 3GPP RAN 502 or the non-3GPP AN 504), the UE 104 applies the ATSSS rules and considers local conditions for triggering the establishment or activation of the user plane resources over another access.

In some cases, the rules governing ATSSS operation (e.g., ATSSS rules defining how to handle traffic across access paths) may be sent from the PCF 514 to the SMF 508, and from the SMF 508 to UE 104 during MA PDU operation. ATSSS rules contain a list of prioritized rules. For example, each ATSSS rule may include a rule precedence and one or more Traffic Descriptors associated with Access Selection Descriptors. An Access Traffic Descriptor (ATD) may include mandatory steering mode information (e.g. active-standby, smallest delay, load-balancing, or priority-based), and optional Steering Functionality information (e.g., multipath transmission control protocol (MPTCP) or ATSSS lower layer functionality (ATSSS-LL). Additional information regarding ATSSS information elements and structure may be found in Table 5.32.8-1 specified in 3GPP TS 23.501 V16.1.0 entitled “3^{rd} Generation Partnership Project; Technical Specification Group Service and System Aspects; System Architecture for 5G System; Stage 2 (Release 16)” dated June 2019, which is incorporated herein by reference in its entirety. ATSSS rules for a given PDU session may be updated during the lifetime of the session; see 3GPP TS 23.501.

### Aspects Related to MA PDU Session Establishment with a Single Subscription

As noted above, ATSSS functionality may enable traffic distribution for MA PDU sessions between an access link associated with a 3GPP RAN (e.g., a “3GPP access link”) and another access link associated with a non-3GPP RAN (e.g., a “non-3GPP access link”). However, there may be cases where an application of a UE may desire to simultaneously use two 3GPP access links, known as dual 3GPP access.

For example, in some cases, UE-implemented applications may be enabled to use multiple 3GPP access links associated with different public lands mobile networks (PLMNs) simultaneously. In some cases, dual 3GPP access via multiple 3GPP access links may be implemented using a single set of user credentials stored in a subscriber identity module (SIM) of the UE. In some cases, implementing dual 3GPP access via a single set of user credentials, may improve network capacity and coverage as experienced by the UE. For example, dual 3GPP access may improve resource sharing without affecting user experience at the UE.

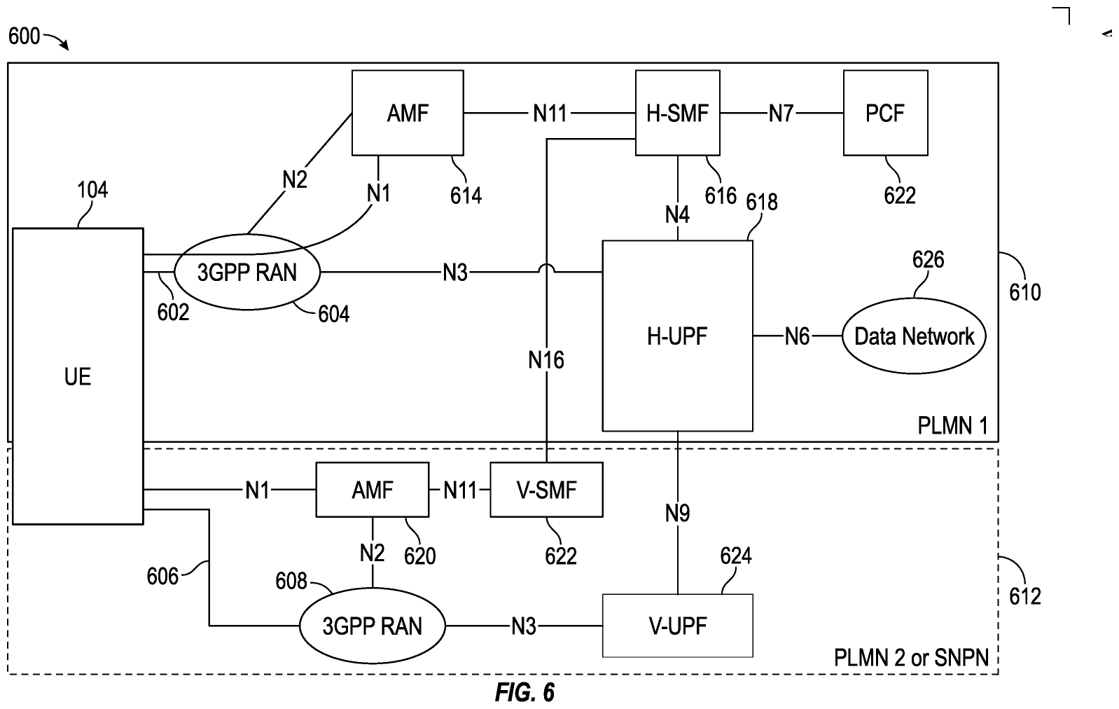

FIG. 6 illustrates an example architecture 600 for facilitating dual 3GPP access for a MA PDU session. For example, as shown, the UE 104 may establish a MA PDU session via a first access link 602 to a first 3GPP RAN 604 and a second access link 606 to a second 3GPP RAN 608. As shown, the first access link 602 and first 3GPP RAN 604 is associated with a first PLMN 610. Similarly, the second access link 606 and second 3GPP RAN 608 are associated with a second PLMN 612. In some cases, the UE 104 may first establish connection to the first 3GPP RAN 604 followed by establishing connection to the second 3GPP RAN 608. As such, the first PLMN 610 may be referred to as a primary PLMN and the second PLMN 612 may be referred to as a secondary PLMN.

Further, as shown, the first PLMN 610 and the second PLMN 612 may each include separate network entities (e.g., AMFs, SMFs, UPFs, etc.) for facilitating UE access to the first PLMN 610, the second PLMN 612, and a data network 626. For example, as shown, the first PLMN 610 may include a first AMF 614, a first SMF 616 (also known as a home-SMF (H-SMF)), a first UPF 618 (also known as a home-UPF (H-UPF)), and a PCF 622. The first AMF 614, first SMF 616, first UPF 618, and PCF 622 may be examples of the AMF, SMF, UPF, and PCF illustrated in FIGS. 1 and/or 4. Similarly, the second PLMN 612 includes a second AMF 620, a second SMF 628 (also known as a visiting-SMF (V-SMF), and a second UPF 624 (also known as a visiting-UPF (V-UPF)). The second AMF 620, second SMF 628, and second UPF 624 may also be examples of the AMF, SMF, UPF, and PCF illustrated in FIGS. 1 and/or 4.

As noted above, a UPF may serve as an anchor for PDU sessions. However, in the case of dual 3GPP access, different legs of an MA PDU session may be associated with different PLMNs, each of which may include a UPF. In such cases, one of the UPFs may serve as a common anchor point for each leg of the MA PDU session. For example, as shown in FIG. 6, a first leg (e.g., first access link 602) and a second leg (e.g., second access link 606) of the MA PDU session may both be anchored by the first UPF 618 in the first PLMN 610. More specifically, for example, while the second leg (e.g., second access link 606) is associated with the second PLMN 612, which includes the second UPF 624, the second leg may still be anchored by the first UPF 618 in the first PLMN 610. In such cases, any traffic associated with the second leg (e.g., from the data network 626) may be routed from the first UPF 618 in the first PLMN 610 to the UE 104 via the second UPF 624 in the second PLMN 612.

In some cases, the PCF 622 may send ATSSS information to the UE 104, including one or more ATSSS rules for deciding how to distribute uplink traffic across the first access link 602 to the first 3GPP RAN 604 and the second access link 606 to the second 3GPP RAN 608. Additionally, the first UPF 618 may use network-provided policy (e.g., N4 rules) from the PCF 622 and feedback information received from the UE 104 for deciding how to distribute the downlink traffic across the first 3GPP RAN 604 and the second 3GPP RAN 608.

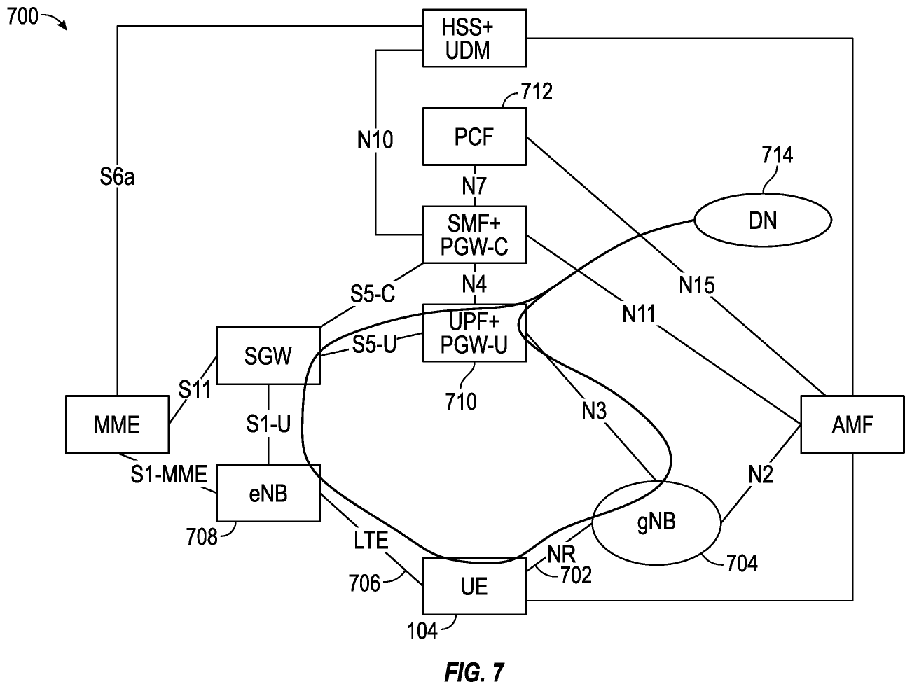

In other cases, rather than establishing legs of a MA PDU session in different PLMNs, there may be cases where these legs may be established within one PLMN but using different radio access technologies (RATs). For example, as illustrated in FIG. 7, the UE 104 may establish a MA PDU session using a first access link 702 to a base station (e.g., gNB) of a 5G RAN 704 in a PLMN via a 5G RAT. The UE 104 may also establish the MA PDU session using a second access link 706 to a base station (e.g., eNB) of an LTE RAN 708 in the PLMN via an LTE RAT. As shown, both legs (e.g., first access link 702 and second access link 706) of the MA PDU session may be anchored by a common UPF 710.

The common UPF 710 may use network-provided policy (e.g., N4 rules) from a PCF 712 and feedback information received from the UE 104 for deciding how to distribute the downlink traffic from a data network 714 across the 5G RAN 704 and the LTE RAN 708. Similarly, the UE 104 may receive ATSSS information from the PCF 712, including one or more ATSSS rules for deciding how to distribute uplink traffic across the first access link 702 to the 5G RAN 704 and the second access link 706 to the LTE RAN 708.

In some cases, while FIG. 7 illustrates the establishment of an MA PDU session via an LTE RAT and a 5G RAT, there may be instances in which the UE 104 could establish the MA PDU session via a terrestrial access link to a terrestrial 5G RAN (e.g., via a terrestrial base station/gNB) as well as a non-terrestrial access link to a non-terrestrial 5G RAN (e.g., via a satellite, unmanned aerial vehicle (UAV), etc.).

In such cases, even if both of the terrestrial access link and the non-terrestrial access link are deployed in a same PLMN, the quality of service (QoS) over the two access link may be significantly different and may fluctuate quite a bit.

In some cases, similar to FIG. 5, the terrestrial access link and the non-terrestrial access link may be associated with different PLMNs having different PLMN IDs (e.g. satellite access using MCC 9xx). Such deployment may allow a network operator to provide service where terrestrial networks are not deployed as well as smooth switching between non-terrestrial and terrestrial networks. Additionally, this deployment may provide a capacity boost when both terrestrial and non-terrestrial networks are available.

In some cases, whether established via two different PLMNs (e.g., as illustrated in FIG. 5) or via two different RATs within on PLMN (e.g., as illustrated in FIG. 7), a dual 3GPP access MA PDU session may be established using a single set of UE credentials stored in a SIM of the UE.

A UE's subscription (e.g., Universal Subscriber Identity Module (USIM)) stores a list of PLMN preferences. In some cases, the list is a prioritized list of PLMN/RAT combinations. In some cases, the list may be known as an Operator-Controlled PLMN Selector with Access Technology file. To establish a PDU session, the UE selects and attempts registration on PLMNs or PLMN/RAT combinations based on the stored list.

In the case of a single-subscription-UE establishing a MA PDU session with a first PLMN and a second PLMN, the UE may attempt registration based on the prioritized list stored in the single subscription. When selecting and attempting to establish an access link with a secondary PLMN, the UE attempts registration on the highest priority PLMN in the list and does not take into account the first, primary PLMN.

For example, the prioritized preference list may include, in order: PLMNₓ, PLMN_{z}, and PLMN_{y}. PLMNₓ and PLMN_{y} work together to enable dual access ATSSS. In such cases, according to current methods, the UE first establishes an access link with PLMNₓ. Thereafter, the UE attempts to register with the PLMN having the next highest priority. In this case, the UE attempts to register with PLMN_{z}. While PLMN_{z} is prioritized higher than PLMN_{y}, it may be desirable for the UE to connect to the lower priority PLMN_{y}, instead of PLMN_{z}, for purposes of ATSSS.

In the case of a single-subscription-UE establishing a MA PDU session with a first RAT of a PLMN and a second RAT of the same PLMN, the UE may similarly attempt registration based on the prioritized list of PLMN/RAT combinations stored in the subscription. In this example, the prioritized list includes, in order, PLMNₓ/RATₐ, PLMNₓ/RAT_{c}, and PLMNₓ/RAT_{b}. The UE may register with RATₐ as the primary RAT and RAT_{c} as the secondary RAT. Further, while RAT_{b} is prioritized lower than RAT_{c}, it may be desirable for the UE to connect to RATₐ and RAT_{b} for purposes of ATSSS.

ATSSS uses bandwidth aggregation to combine two access links. Relying on the prioritized list of PLMN/RAT combinations may be sufficient for standalone PLMN selection, but may not be sufficient to support ATSSS and may lead to inefficiencies bandwidth aggregation. Accordingly, aspects of the present disclosure include techniques for supporting ATSSS during MA PDU session establishment. For example, in some cases, to help support ATSSS during MA PDU session establishment, a single-subscription-UE may be configured to take into account the established primary access link when selecting a secondary RAT or secondary PLMN/RAT combination.

For example, the techniques presented herein may involve the use of a first prioritized list and a second prioritized list. More specifically, for example, the UE may use the first prioritized list for selecting a primary PLMN/RAT for a first access link. Next, when the UE intends to set up a dual 3GPP access MA PDU session, the UE may use the second prioritized list to select a secondary PLMN or RAT to be used for a second access link of the dual 3GPP access MA PDU session. In some cases, the second prioritized list may be an ATSSS-specific prioritized list of PLMN/RAT combinations for ATSSS use cases. In some cases, the first prioritized list may be included within a first selection file and the second prioritized list may be included within a second selection file (e.g., an ATSSS PLMN selector with access technology file). Accordingly, by using the ATSSS-specific prioritized list to select the PLMN or RAT for the second access link, the UE may help to ensure that a PLMN or RAT selected for the second access link is optimal for ATSSS functionality.

### Example Call Flow Illustrating Example Operations for Establishing a Dual 3GPP Access PDU Session with ATSSS Functionality

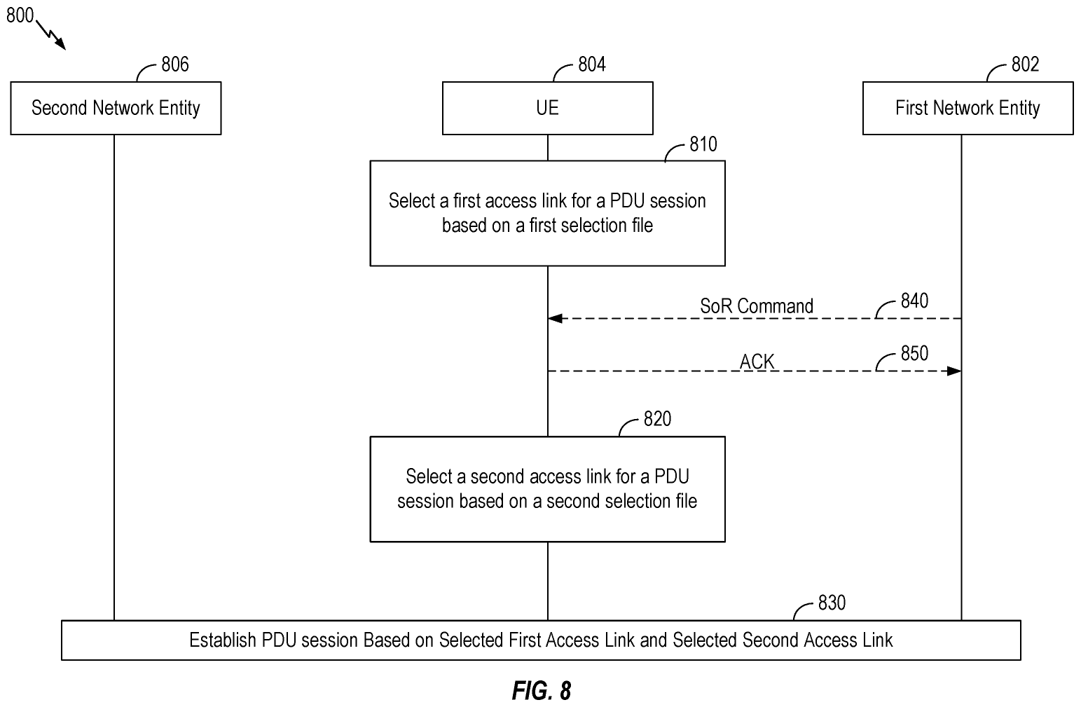

FIG. 8 illustrates an example call flow diagram illustrating operations 800 for establishing a dual 3GPP access PDU session with ATSSS functionality. As will be explained in greater detail below, establishing the dual 3GPP access PDU session with ATSSS functionality may include selecting a second access link for the dual 3GPP PDU session based on an established first access link.

As shown, the operations 800 may be performed by a first network entity 802, a UE 804, and a second network entity 806. In some cases, the first network entity 802 may be an example of the BS 102 illustrated in FIGS. 1 and 3 and/or a distributed base station as illustrated in FIG. 2. In some cases, the second network entity 806 may be another example of the BS 102 illustrated in FIGS. 1 and 3 and/or a distributed base station as illustrated in FIG. 2. Similarly, the UE 804 may be an example of the UE 104 illustrated in FIGS. 1 and 3.

In some cases, the first network entity 802 may be associated with a first PLMN (e.g., a primary PLMN) while the second network entity 806 may be associated with a second PLMN (e.g., a secondary PLMN). In other cases, the first network entity 802 and the second network entity 806 may be associated with a same PLMN (e.g., the first PLMN) but associated with different RATs. For example, in some cases, the first network entity 802 may be associated with a first RAT (e.g., 5G) while the second network entity 806 is associated with a second RAT (e.g., LTE).

As illustrated, operations 800 begin in step 810, with the UE 804 selecting a first access link for a dual 3GPP access PDU session based on a first selection file, including a first list of prioritized primary PLMNs and RAT combinations. In some cases, the first selection file comprises an operator controlled PLMN selector with access technology elementary file (EF). In some cases, selecting the first access link for the dual 3GPP access PDU session may include selecting a first PLMN and RAT for the dual 3GPP access PDU session based on the list of prioritized primary PLMNs and RAT combinations included in the first selection file. In some cases, the first selection file may be stored in a SIM of the UE 804.

Thereafter, in step 820, the UE 804 selects a second access link for the dual 3GPP access PDU session. In some cases, the first access link comprises a first 3GPP-based access link for the dual 3GPP PDU session and the second access link comprises a second 3GPP-based access link for the dual 3GPP PDU session.

In some cases, selecting the second access link may be based on the first access link. More specifically, for example, selecting the second access link may be based on one or more UE route selection policy (USRP) rules associated with the first access link. For example, the UE 804 may receive USRP rules from the first network entity 802 of the first PLMN. In some cases, the UE 804 may be preconfigured with the USRP rules. Thereafter, the UE 804 selects a USRP rule based on the traffic requirement of an application launched at the UE 804 (e.g., by a user of the UE 804). When, based on the traffic requirement of the application, the USRP rule (e.g., a route selection descriptor component of the USRP rule) indicates to set up a dual 3GPP PDU session, UE 804 may select the second access link as illustrated in step 820.

In some cases, selecting the second access link may be further based on a second selection file. In some cases, the second selection file comprises an ATSSS PLMN EF including a second list of prioritized secondary PLMNs and RAT combinations. In some cases, the second selection file may take into account support for ATSSS with the established first access link. In some cases, selecting the second access link may include selecting either (1) a second PLMN and a second RAT within the second PLMN for the dual 3GPP access PDU session based on the second list of prioritized secondary PLMNs and RAT combinations in the second selection file or (2) selecting a second RAT within the first PLMN (e.g., associated with the first access link) based on the second list of prioritized secondary PLMNs and RAT combinations in the second selection file. In some cases, the second selection file may be stored in a SIM of the UE 804. In some cases, a mobile entity (ME) of the UE 804 may support storage of the second selection file in the ME.

Thereafter, in step 830, UE 804 establishes the dual 3GPP access PDU session with the first network entity 802 and the second network entity 806 based on the selected first access link and the second access link. In some cases, the first access link and the second access link may be established based on one set of credentials, which may be stored in a single SIM of the UE 804. In some cases, the UE 804 may establish the first access link of the dual 3GPP access PDU session prior to selecting the second access link. In some cases, once the dual 3GPP access PDU session is established, the UE 804 may communicate with both the first network entity 802 and the second network entity 806. For example, the UE 804 may use the first access link to transmit and receive information to/from the first network entity 802 while also using the second access link to transmit and receive information to/from the second network entity 806.

In some cases, prior to selecting the second access link and establishing the dual 3GPP access PDU session, the UE may receive a steering of roaming (SoR) command from the first network entity 802 associated with the first access link and first PLMN, as in step 840 in FIG. 8. The SoR command may be used by the first network entity 802 to update at least one of the first selection file or the second selection file of the UE 804. In some cases, the SoR command may be transmitted by an entity in a core network of the first PLMN via a transparent container.

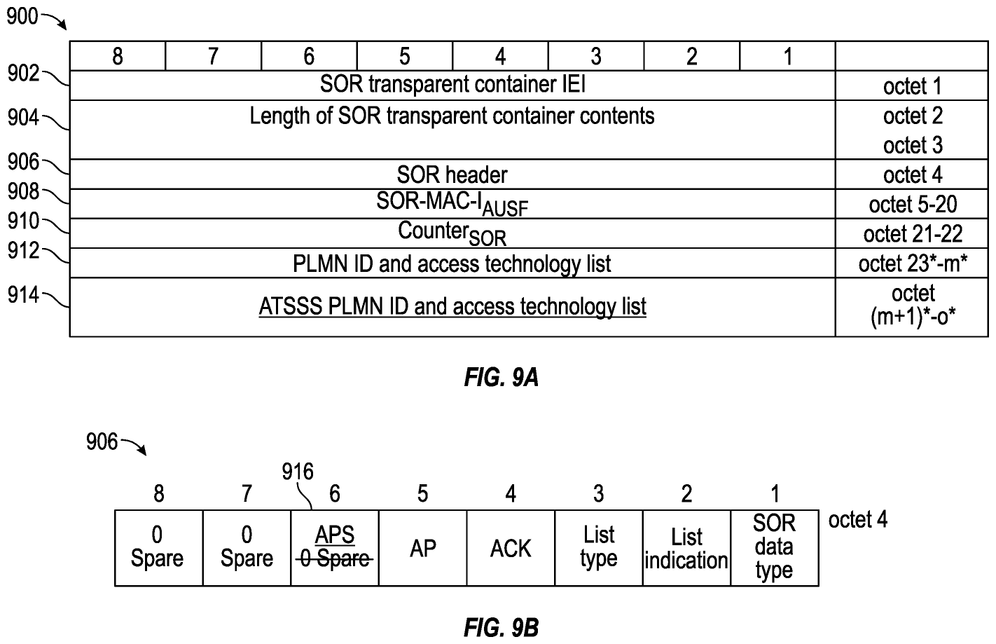

FIG. 9A illustrates an example SoR command 900 that may be used to update the second selection file. As shown, the SoR command 900 includes a plurality of fields, such as an SoR transparent container information element identifier (IEI) field 902, a length of SoR transparent container contents field 904, an SoR header 906, an SoR media access control (MAC) authentication server function (SoR-MAC-I_{AUSF}) field 908, an SoR counter field 910, a PLMN ID and access technology list field 912 (e.g., which may include updated information for the first selection file), and an ATSSS PLMN ID and access technology list field 914 (e.g., which may include updated information for the second selector list).

FIG. 9B provides a more detailed illustration of the SoR header 906 of the SoR command 900. For example, as shown in FIG. 9B, the SoR header 906 may include an ATSSS PLMN selector (APS) list value field 916. In some cases, the APS list value field 916 may use a spare or reserved bit field of the SoR header 906. Additionally, in some cases, the APS list value field 916 may include an indication of whether the SoR command 900 includes updated information for the second selection file. For example, a bit value of “0” (zero) in the APS list value field 916 may indicate that the SoR command 900 does not include updated information for the second selection file while a bit value of “1” (one) indicates that the SoR command 900 includes updated information for the second selection file, or vice versa.

Accordingly, when the APS list value field 916 indicates that the SoR command 900 includes the updated information (e.g., when the APS list value field 916 includes a bit value of “1”, in some cases), the updated information for the second selection file may be included within the ATSSS PLMN ID and access technology list field 914 of the SoR command 900 illustrated in FIG. 9A.

In some cases, the updated information for the second selection file included within the ATSSS PLMN ID and access technology list field 914 may comprise an updated list of prioritized secondary PLMNs and RAT combinations. In some cases, the updated list of prioritized secondary PLMNs and RAT combinations may include a list of PLMN identifiers (IDs) and access technologies (e.g., RATs) in decreasing order of priority. For example, PLMN ID #1 indicates highest priority and PLMN ID n indicates lowest priority. In some cases, the updated list may include a maximum of 16 PLMN IDs and access technology (e.g., RAT) identifiers.

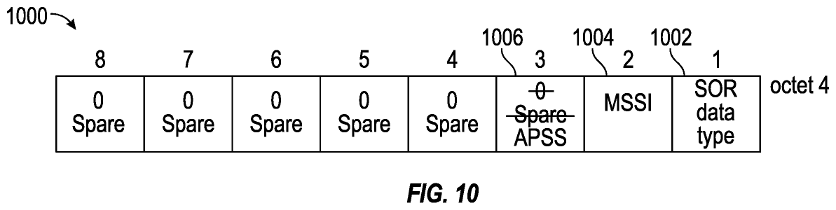

Returning to FIG. 8, in response to receiving the SoR command, the UE 804 transmits an acknowledgement message at 850, acknowledging receipt of the SoR command. FIG. 10 illustrates an example acknowledgement message 1000 for acknowledging receipt of an SoR command, such as the SoR command 900, received from the first network entity 802. In some cases, the acknowledgement message 1000 transmitted in step 850 by the UE 804 may include a plurality of fields, such as a SoR data type field 1002, a mobile entity (ME) support of steering of roaming connected mode control information indicator (MSSI) value field 1004, an ME support of ATSSS selector list indication (APSS) value field 1006, and several spare or reserved fields.

In some cases, the APSS value field 1006 may be used to indicate whether an ME of the UE supports use of the second selection file. More specifically, the APSS value field 1006 may indicate whether the ME of the UE 804 supports the updated information included within the ATSSS PLMN ID and access technology list field 914 of the SoR command 900. For example, in some cases, a bit value of “0” (zero) in the APSS value field 1006 may indicate that the second selection file is not supported by the ME of the UE 804 while a bit value of “1” one in the APSS value field 1006 may indicate that the second selector file is supported by the ME of the UE 804, or vice versa.

In some cases, when the ME of the UE 804 supports use of the second selection file, the UE 804 may update the second selection file based on the updated information for the second selection file in the ATSSS PLMN ID and access technology list field 914 of the SoR command 900. Thereafter, the UE 804 may store the updated second selection file in the ME of the UE 804.

In some cases, when the UE 804 receives an SoR command with updated information for the section selection file, as illustrated at 840 in FIG. 8, and the ME of the UE 804 supports use of the second selection file, selecting the second access link based on the second selection file in step 820 of FIG. 8 comprises selecting the second access link based on the updated second selection file stored in the ME of the UE 804.

In some cases, when the ME of the UE 804 supports use of the second selection file in the ME but the UE 804 has not received an SoR command (e.g., from the first network entity 802 or the second network entity 806) including the updated information for the second selection file, selecting the second access link based on the second selection file in step 820 comprises selecting the second access link based on the second selection file stored in the SIM of the UE. Additionally, in some cases, when the ME of the UE 804 does not support use of the second selection file, the UE 804 may not use the second selection file to select the second access link. In such cases, the UE 804 may instead use the first selection file to select the second access link.

As noted above, in some cases, the second selection file may be stored in the ME of the UE 804. In some cases, however, the UE 804 may detect a new SIM has been inserted into the UE. When this occurs and when the second selection file is stored in the ME of the UE, the UE 804 may delete, the second selection file from the ME of the UE 804 in response to detecting the new SIM.

### Example Method for Establishing a Dual 3GPP Access PDU Session with ATSSS Functionality

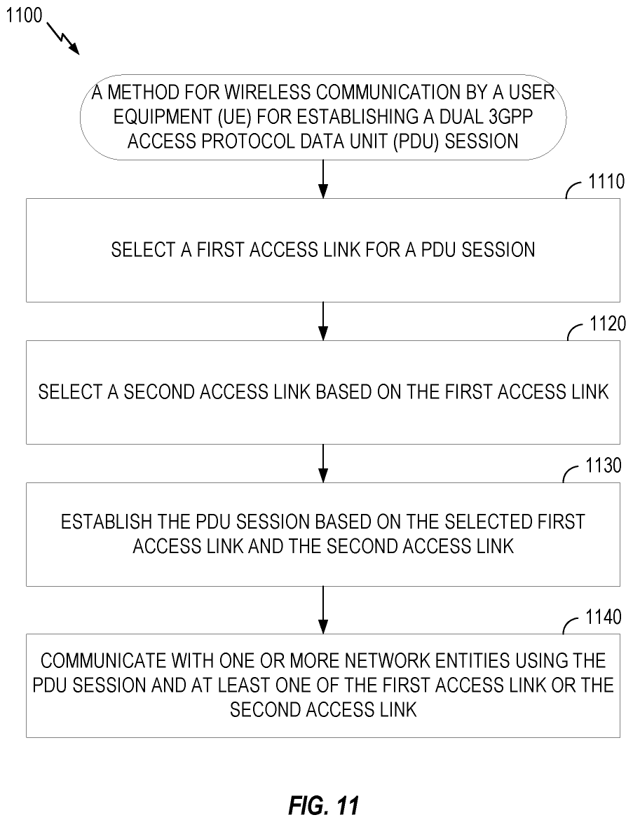

FIG. 11 shows a method 1100 for wireless communications by a UE, such as UE 104 of FIGS. 1 and 3.

Method 1100 begin in step 1110 with the UE selecting a first access link for a PDU session.

In step 1120, the UE selects a second access link based on the first access link.

In step 1130, the UE establishes the PDU session based on the selected first access link and the second access link.

In step 1140, the UE communicates with one or more network entities using the PDU session and at least one of the first access link or the second access link.

In some cases, the PDU session comprises a dual third generation partnership project (3GPP) PDU session. In some cases, the first access link comprises a first 3GPP-based access link for the dual 3GPP PDU session. In some cases, the second access link comprises a second 3GPP-based access link for the dual 3GPP PDU session.

In some cases, the first access link is associated with a first PLMN and a first RAT. Additionally, in some cases, the second access link is associated with one of: the first PLMN and a second RAT, or a second PLMN and a second RAT.

In some cases, selecting the first access link in step 1110 is based on a first selection file. Further, in some cases, selecting the second access link in step 1120 is based on a second selection file.

In some cases, the first selection file comprises an operator controlled PLMN selector with access technology EF. Additionally, in some cases, the second selection file comprises an ATSSS PLMN EF.

In some cases, the first selection file comprises a list of prioritized primary PLMNs and RAT combinations. Additionally, in some cases, the second selection file comprises a list of prioritized secondary PLMNs and RAT combinations.

In some cases, selecting the second access link in step 1120 is further based on a UE URSP rule associated with the first PLMN and a traffic requirement associated with the PDU session.

In some cases, the second selection file is stored in a SIM of the UE.

In some cases, method 1100 further include receiving a SoR command from a network entity. In such cases, the SoR command may include an indication that the SoR command includes updated information for the second selection file. Additionally, in some cases, the SoR command may further include the updated information for the second selection file, wherein the updated information for the second selection file includes an updated list of prioritized secondary PLMNs and RAT combinations.

In some cases, method 1100 further include transmitting, to the network entity, an indication of whether an ME of the UE supports use of the second selection file.

In some cases, method 1100 further include, when the ME of the UE supports use of the second selection file, updating the second selection file based on the updated information for the second selection file in the SoR command. In some cases, method 1100 further include storing the updated second selection file in the ME, wherein selecting the second access link based on the second selection file comprises selecting the second access link based on the updated second selection file stored in the ME.

In some cases, when the ME of the UE supports use of the second selection file in the ME but the UE has not received a SoR command from a network entity including updated information for the second selection file, selecting the second access link based on the second selection file in step 1120 comprises selecting the second access link based on the second selection file stored in the SIM of the UE.

In some cases, when the ME of the UE supports use of the second selection file in the ME and the UE has received the SoR command from the network entity including the updated information for the second selection file, selecting the second access link based on the second selection file in step 1120 comprises selecting the second access link based on an updated second selection file stored in the ME of the UE.

In some cases, method 1100 further include detecting a new SIM has been inserted into the UE. Additionally, in some cases, method 1100 further include deleting, when the second selection file is stored in an ME of the UE, the second selection file from the ME of the UE in response to detecting the new SIM.

In some cases, establishing the PDU session in step 1130 is further based on one set of credentials for the first access link and the second access link.

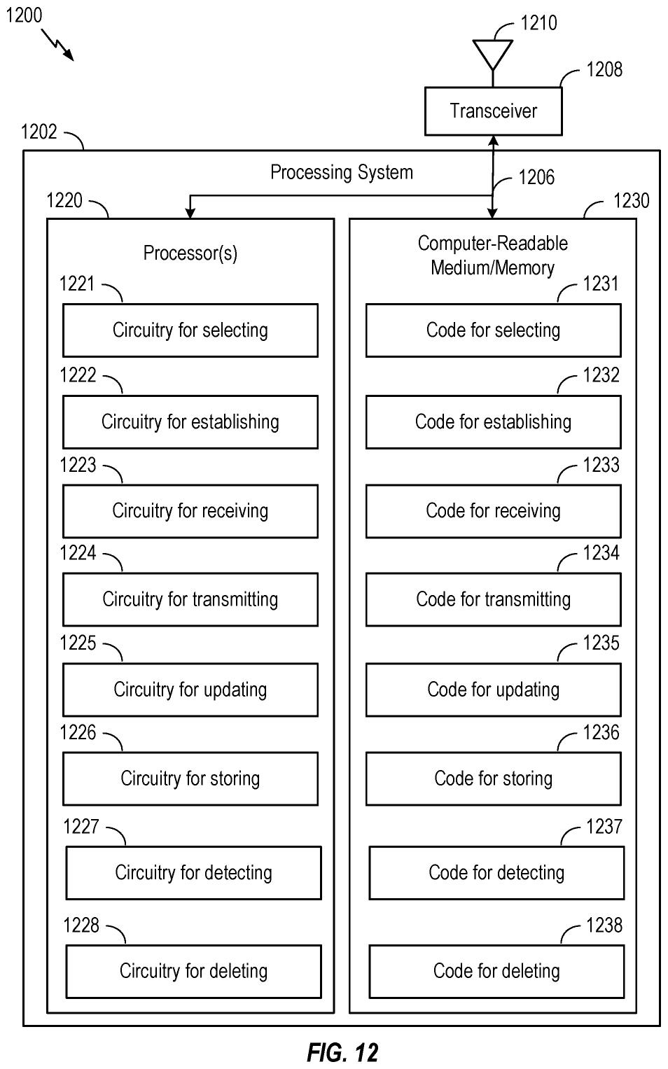

In one aspect, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative steps are possible consistent with this disclosure.

### Example Wireless Communication Devices

FIG. 12 depicts aspects of an example communications device 1200. In some aspects, communications device 1200 is a user equipment, such as UE 104 described above with respect to FIGS. 1 and 3.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may be representative of one or more of receive processor 358, transmit processor 364, TX MIMO processor 366, and/or controller/processor 380, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1100 described with respect to FIG. 11, or any aspect related to it. Note that reference to a processor performing a function of communications device 1200 may include one or more processors performing that function of communications device 1200.

In the depicted example, computer-readable medium/memory 1230 stores code (e.g., executable instructions) for selecting 1231, code for establishing 1232, code for receiving 1233, code for transmitting 1234, code for updating 1235, code for storing 1236, code for detecting 1237, and code for deleting 1238. Processing of the code 1231-1238 may cause the communications device 1200 to perform the method 1100 described with respect to FIG. 11, or any aspect related to it.

The one or more processors 1220 include circuitry configured to implement (e.g., execute) the code stored in the computer-readable medium/memory 1230, including circuitry for circuitry for selecting 1221, circuitry for establishing 1222, circuitry for receiving 1223, circuitry for transmitting 1224, circuitry for updating 1225, circuitry for storing 1226, circuitry for detecting 1227, and for deleting 1228. Processing with circuitry 1221-1228 may cause the communications device 1200 to perform the method 1100 described with respect to FIG. 11, or any aspect related to it.

Various components of the communications device 1200 may provide means for performing the method 1100 described with respect to FIG. 11, or any aspect related to it. For example, means for transmitting, sending or outputting for transmission may include the transceivers 354 and/or antenna(s) 352 of the UE 104 illustrated in FIG. 3 and/or transceiver 1208 and antenna 1210 of the communications device 1200 in FIG. 12. Means for receiving or obtaining may include the transceivers 354 and/or antenna(s) 352 of the UE 104 illustrated in FIG. 3 and/or transceiver 1208 and antenna 1210 of the communications device 1200 in FIG. 12. Additionally, means for selecting, means for establishing, means for updating, means for storing, means for detecting, and means for deleting may include one or more processors, such as the controller/processor 380, the receive processor 358, the transmit processor 364, and/or memory 382 of the UE 103 illustrated in FIG. 3 and/or the processor 1220 and computer-readable medium/memory 1230 of the communications device 1200.

### Example Clauses

Implementation examples are described in the following numbered clauses:
Clause 1: A method for wireless communication by a user equipment (UE), comprising: selecting a first access link for a protocol data unit (PDU) session; selecting a second access link based on the first access link; and establishing the PDU session based on the selected first access link and the second access link.
Clause 2: The method of Clause 1, wherein: the first access link is associated with a first public land mobile network (PLMN) and a first radio access technology (RAT), and the second access link is associated with one of: the first PLMN and a second RAT, or a second PLMN and a second RAT.
Clause 3: The method of any of Clauses 1-2, wherein: selecting the first access link is based on a first selection file, and selecting the second access link is based on a second selection file.
Clause 4: The method of Clause 3, wherein: the first selection file comprises an operator controlled public land mobile network (PLMN) selector with access technology elementary file (EF), and the second selection file comprises an access traffic steering, switching and splitting (ATSSS) PLMN EF.
Clause 5: The method of Clause 4, wherein: the first selection file comprises a list of prioritized primary PLMNs and RAT combinations, and the second selection file comprises a list of prioritized secondary PLMNs and RAT combinations.
Clause 6: The method of any of Clauses 3-5, wherein selecting the second access link is further based on a UE route selection policy (URSP) rule associated with the first PLMN and a traffic requirement associated with the PDU session.
Clause 7: The method of any of Clauses 3-6, wherein the second selection file is stored in a subscriber identification module (SIM) of the UE.
Clause 8: The method of Clause 7 further comprising receiving a steering of roaming (SoR) command from a network entity, the SOR command comprising: an indication that the SoR command includes updated information for the second selection file; and the updated information for the second selection file, wherein the updated information for the second selection file includes an updated list of prioritized secondary PLMNs and RAT combinations.
Clauses 9: The method of Clause 8, further comprising transmitting, to the network entity, an indication of whether a mobile entity (ME) of the UE supports use of the second selection file.
Clause 10: The method of Clause 9, further comprising, when the ME of the UE supports use of the second selection file: updating the second selection file based on the updated information for the second selection file in the SoR command, and storing the updated second selection file in the ME, wherein selecting the second access link based on the second selection file comprises selecting the second access link based on the updated second selection file stored in the ME.
Clause 11: The method of Clauses 10, further comprising: detecting a new subscriber identification module (SIM) has been inserted into the UE; and deleting, when the second selection file is stored in a mobile entity (ME) of the UE, the second selection file from the ME of the UE in response to detecting the new SIM.
Clause 12: The method of Clauses 9-11, wherein: when the ME of the UE does supports storage use of the second selection file in the ME but the UE has not received a steering of roaming (SoR) command from a network entity including updated information for the second selection file, selecting the second access link based on the second selection file comprises selecting the second access link based on the second selection file stored in the SIM of the UE, and when the ME of the UE does supports storage use of the second selection file in the ME and the UE has received the SoR command from the network entity including the updated information for the second selection file, selecting the second access link based on the second selection file comprises selecting the second access link based on an updated second selection file stored in the ME of the UE.
Clause 13: The method of any of Clauses 1-12, wherein establishing the PDU session is further based on one set of credentials for: the first access link, and the second access link.
Clause 14: The method of any of Clauses 1-13, wherein: the PDU session comprises a dual third generation partnership project (3GPP) PDU session; the first access link comprises a first 3GPP-based access link for the dual 3GPP PDU session; and the second access link comprises a second 3GPP-based access link for the dual 3GPP PDU session.
Clause 15: An apparatus, comprising: at least one processor; and a memory coupled to the at least one processor, the memory including instructions executable by the at least one processor to cause the apparatus to perform a method in accordance with any one of Clauses 1-14.
Clause 16: An apparatus, comprising means for performing a method in accordance with any one of Clauses 1-14.
Clause 17: A non-transitory computer-readable medium comprising executable instructions that, when executed by one or more processors of an apparatus, cause the apparatus to perform a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a user equipment (UE), comprising:
selecting a first access link for a protocol data unit (PDU) session;
selecting a second access link based on the first access link; and
establishing the PDU session based on the selected first access link and the second access link.

2. The method of claim 1, wherein:
the PDU session comprises a dual third generation partnership project (3GPP) PDU session;
the first access link comprises a first 3GPP-based access link for the dual 3GPP PDU session; and
the second access link comprises a second 3GPP-based access link for the dual 3GPP PDU session.

3. The method of claim 1, wherein:
the first access link is associated with a first public land mobile network (PLMN) and a first radio access technology (RAT), and
the second access link is associated with one of:
the first PLMN and a second RAT, or
a second PLMN and a second RAT.

4. The method of claim 3, wherein:
selecting the first access link is based on a first selection file, and
selecting the second access link is based on a second selection file.

5. The method of claim 4, wherein:
the first selection file comprises an operator controlled public land mobile network (PLMN) selector with access technology elementary file (EF), and
the second selection file comprises an access traffic steering, switching and splitting (ATSSS) PLMN EF.

6. The method of claim 5, wherein:
the first selection file comprises a list of prioritized primary PLMNs and RAT combinations, and
the second selection file comprises a list of prioritized secondary PLMNs and RAT combinations.

7. The method of claim 4, wherein selecting the second access link is further based on a UE route selection policy (URSP) rule associated with the first PLMN and a traffic requirement associated with the PDU session.

8. The method of claim 4, wherein the second selection file is stored in a subscriber identification module (SIM) of the UE.

9. The method of claim 8, further comprising receiving a steering of roaming (SoR) command from a network entity, the SOR command comprising:
an indication that the SoR command includes updated information for the second selection file; and
the updated information for the second selection file, wherein the updated information for the second selection file includes an updated list of prioritized secondary PLMNs and RAT combinations.

10. The method of claim 9, further comprising transmitting, to the network entity, an indication of whether a mobile entity (ME) of the UE supports use of the second selection file.

11. The method of claim 10, further comprising, when the ME of the UE supports use of the second selection file:
updating the second selection file based on the updated information for the second selection file in the SoR command; and
storing the updated second selection file in the ME, wherein selecting the second access link based on the second selection file comprises selecting the second access link based on the updated second selection file stored in the ME.

12. The method of claim 11, further comprising:
detecting a new subscriber identification module (SIM) has been inserted into the UE; and
deleting, when the second selection file is stored in a mobile entity (ME) of the UE, the second selection file from the ME of the UE in response to detecting the new SIM.

13. The method of claim 10, wherein:
when the ME of the UE supports use of the second selection file in the ME but the UE has not received a steering of roaming (SoR) command from a network entity including updated information for the second selection file, selecting the second access link based on the second selection file comprises selecting the second access link based on the second selection file stored in the SIM of the UE, and
when the ME of the UE supports use of the second selection file in the ME and the UE has received the SoR command from the network entity including the updated information for the second selection file, selecting the second access link based on the second selection file comprises selecting the second access link based on an updated second selection file stored in the ME of the UE.

14. The method of claim 1, wherein establishing the PDU session is further based on one set of credentials for:
the first access link, and
the second access link.

15. An apparatus for wireless communication, comprising:
at least one processor; and
a memory coupled to the at least one processor, the memory including instructions executable by the at least one processor to cause the apparatus to:
select a first access link for a protocol data unit (PDU) session;
select a second access link based on the first access link; and
establish the PDU session based on the selected first access link and the second access link.

16. The apparatus of claim 15, wherein:
the PDU session comprises a dual third generation partnership project (3GPP) PDU session;
the first access link comprises a first 3GPP-based access link for the dual 3GPP PDU session; and
the second access link comprises a second 3GPP-based access link for the dual 3GPP PDU session.

17. The apparatus of claim 15, wherein:
the first access link is associated with a first public land mobile network (PLMN) and a first radio access technology (RAT), and
the second access link is associated with one of:
the first PLMN and a second RAT, or
a second PLMN and a second RAT.

18. The apparatus of claim 17, wherein:
the at least one processor is configured to cause the apparatus to select the first access link based on a first selection file, and
the at least one processor is configured to cause the apparatus to select the second access link based on a second selection file.

19. The apparatus of claim 18, wherein:
the first selection file comprises an operator controlled public land mobile network (PLMN) selector with access technology elementary file (EF), and
the second selection file comprises an access traffic steering, switching and splitting (ATSSS) PLMN EF.

20. The apparatus of claim 19, wherein:
the first selection file comprises a list of prioritized primary PLMNs and RAT combinations, and
the second selection file comprises a list of prioritized secondary PLMNs and RAT combinations.

21. The apparatus of claim 18, wherein the at least one processor is configured to cause the apparatus to select the second access link further based on a UE route selection policy (URSP) rule associated with the first PLMN and a traffic requirement associated with the PDU session.

22. The apparatus of claim 18, wherein the second selection file is stored in a subscriber identification module (SIM) of the apparatus.

23. The apparatus of claim 22, wherein the at least one processor is further configured to cause the apparatus to receive a steering of roaming (SoR) command from a network entity, the SOR command comprising:
an indication that the SoR command includes updated information for the second selection file; and
the updated information for the second selection file, wherein the updated information for the second selection file includes an updated list of prioritized secondary PLMNs and RAT combinations.

24. The apparatus of claim 23, wherein the at least one processor is further configured to cause the apparatus to transmit, to the network entity, an indication of whether a mobile entity (ME) of the apparatus supports use of the second selection file.

25. The apparatus of claim 24, wherein, when the ME of the apparatus supports use of the second selection file, the at least one processor is further configured to cause the apparatus to:
update the second selection file based on the updated information for the second selection file in the SoR command; and
store the updated second selection file in the ME, wherein selecting the second access link based on the second selection file comprises selecting the second access link based on the updated second selection file stored in the ME.

26. The apparatus of claim 25, the at least one processor is further configured to cause the apparatus to:
detect a new subscriber identification module (SIM) has been inserted into the apparatus; and
delete, when the second selection file is stored in a mobile entity (ME) of the apparatus, the second selection file from the ME of the apparatus in response to detecting the new SIM.

27. The apparatus of claim 24, wherein:
when the ME of the apparatus supports use of the second selection file in the ME but the apparatus has not received a steering of roaming (SoR) command from a network entity including updated information for the second selection file, the at least one processor is further configured to cause the apparatus to select the second access link based on the second selection file stored in the SIM of the apparatus, and
when the ME of the apparatus supports use of the second selection file in the ME and the apparatus has received the SoR command from the network entity including the updated information for the second selection file, the at least one processor is further configured to cause the apparatus to select the second access link based on an updated second selection file stored in the ME of the apparatus.

28. The apparatus of claim 15, wherein the at least one processor is further configured to cause the apparatus to establish the PDU session further based on one set of credentials for:
the first access link, and
the second access link.

29. An apparatus for wireless communication, comprising:
means for selecting a first access link for a protocol data unit (PDU) session;
means for selecting a second access link based on the first access link; and
means for establishing the PDU session based on the selected first access link and the second access link.

30. A non-transitory computer-readable medium comprising executable instructions that, when executed by one or more processors of an apparatus, cause the apparatus to:
select a first access link for a protocol data unit (PDU) session;
select a second access link based on the first access link; and
establish the PDU session based on the selected first access link and the second access link.
